(19) United States
(12) Patent Application Publication
(10) Pub. No.: US 2015/0226899 A1
(43) Pub. Date: Aug. 13, 2015

(54) BACK LIGHT MODULE

(71) Applicant: Lextar Electronics Corporation, Hsinchu (TW)

(72) Inventor: Yin-Cyuan Wu, Yunlin County (TW)

(21) Appl. No.: 14/563,013

(22) Filed: Dec. 8, 2014

(30) Foreign Application Priority Data
Feb. 12, 2014 (TW) 103104518

(51) Int. Cl. F21V 8/00

(52) U.S. Cl. CPC G02B 6/003

(57) ABSTRACT

A back light module comprising a light-emitting module, a light transparent refraction plate and a light guide plate is disclosed. The light-emitting module comprises a substrate and several light-emitting components disposed on the substrate. Each light-emitting component has a light-emitting surface. The light transparent refraction plate is disposed on the substrate and has several apertures. Each aperture exposes a corresponding light-emitting surface, and has a sidewall higher than the light-emitting surface. The light guide plate has a lateral light incident surface facing the light-emitting surface and pressing the light transparent refraction plate. The refractive index of the light transparent refraction plate is larger than that of the light guide plate, such that the light emitted by each light-emitting component will enter the light guide plate after passing through the light transparent refraction plate.

This application claims the benefit of Taiwan application Serial No. 103104518, filed on Feb. 12, 2014, the subject matter of which is incorporated herein by reference.

### BACKGROUND OF THE INVENTION

1. Field of the Invention

The invention relates in general to a back light module, and more particularly to a back light module with a refraction plate.

2. Description of the Related Art

A conventional display device comprises a display panel and a back light module. The back light module emits a light to a display panel for the display panel to display an image. The area of a display region of the display panel is determined according to a uniform light-emitting area provided by the back light module. If the uniform light-emitting area provided by the back light module is small, the area of the display region of the display panel will be correspondingly small, and the border of the display panel will become relatively too wide. Therefore, how to increase the uniform light-emitting area provided by the back light module so as to increase the area of the display region of the display panel has become one of the prominent tasks for the industries.

### SUMMARY OF THE INVENTION

The invention is directed to a back light module of an embodiment capable of increasing a uniform light-emitting area of the back light module, hence increasing the area of a display region of a display panel.

According to one embodiment of the present invention, a back light module comprising a light-emitting module, a light transparent refraction plate and a light guide plate is disclosed. The light-emitting module comprises a substrate and several light-emitting components disposed on the substrate. Each light-emitting component has a light-emitting surface. The light transparent refraction plate is disposed on the substrate and has several apertures. Each aperture exposes a corresponding light-emitting surface, and has a sidewall higher than the light-emitting surface. The light guide plate has a lateral light incident surface facing the light-emitting surface and pressing the light transparent refraction plate. The refractive index of the light transparent refraction plate is larger than that of the light guide plate, such that the light emitted by each light-emitting component is refracted to the light guide plate after passing through the light transparent refraction plate.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A is an explosion diagram of a back light module according to an embodiment of the invention.

FIG. 1B is an assembly diagram of FIG. 1A.

FIG. 2 is a cross-sectional view of a back light module according to another embodiment of the invention.

FIG. 3 is a cross-sectional view of a back light module according to another embodiment of the invention.

FIG. 4 is a cross-sectional view of a light-emitting module and a light transparent refraction plate according to another embodiment of the invention.

FIG. 5 is a cross-sectional view of a back light module according to another embodiment of the invention.

FIG. 6 is a cross-sectional view of a back light module according to another embodiment of the invention.

FIG. 7 is a cross-sectional view of a back light module according to another embodiment of the invention.

FIG. 8 is a cross-sectional view of a back light module according to another embodiment of the invention.

FIG. 9 is a cross-sectional view of a light-emitting module and a light transparent refraction plate according to another embodiment of the invention.

FIG. 10 is top view of a light-emitting module and a light transparent refraction plate according to another embodiment of the invention.

FIG. 11 is a top view of a light-emitting module and a light transparent refraction plate according to another embodiment of the invention.

### DETAILED DESCRIPTION OF THE INVENTION

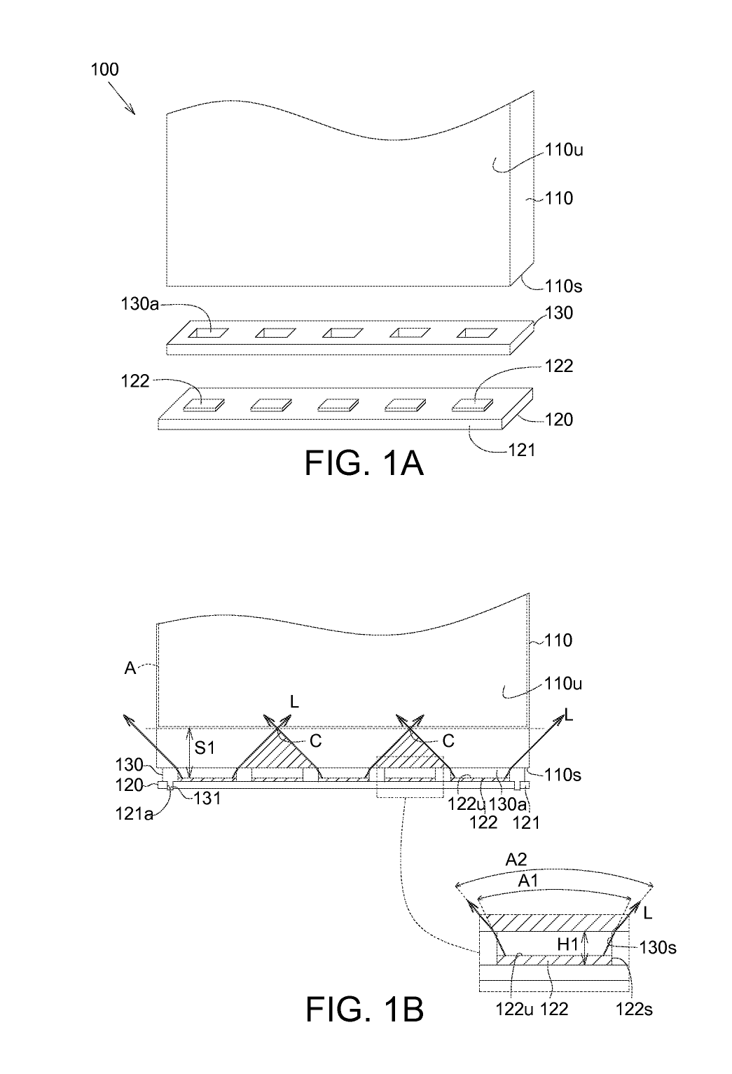

Refer to FIGS. 1A and 1B. FIG. 1A is an explosion diagram of a back light module according to an embodiment of the invention. FIG. 1B is an assembly diagram of FIG. 1A. The back light module 100 comprises a light guide plate 110, a light-emitting module 120 and a light transparent refraction plate 130.

As indicated in FIG. 1B, the lateral side of the light guide plate 110 has a light incident surface 110s facing the light-emitting module 120 and pressing the light transparent refraction plate 130, such that the light L emitted by the light-emitting module 120 enters the light guide plate 110 via the light incident surface 110s.

The light-emitting module 120 comprises a substrate 121 and several light-emitting components 122. The light-emitting components 122, such as LEDs or other light sources, are disposed on the substrate 121. Each light-emitting component 122 has a light-emitting surface 122u. The light emitted by the light-emitting component 122 is outputted via the light output surface 110u of the light guide plate 110 after entering the light guide plate 110 via the light incident surface 110s of the light guide plate 110. The light L emitted from the edge of the light-emitting surface 122u enters the light guide plate 110 via the light incident surface 110s of the light guide plate 110 after passing through the light transparent refraction plate 130.

The refractive index of the light transparent refraction plate 130 is larger than that of the light guide plate 110, such that when the light L emitted by each light-emitting component 122 passes through the light transparent refraction plate 130 and reaches the light guide plate 110, the refraction angle is larger than the incident angle and the divergent angle is increased (extension of the light). As indicated in FIG. 1B, the lights L emitted by two adjacent light-emitting components 122 intersect at a junction C. The refraction angle A2 of the light L after expansion is larger than the beam angle A1 of the light L before expansion, hence shortening the light mixing distance S1 and increasing the area A via which the light L is uniformly outputted from the light output surface 110u of the light guide plate 110 (the light is uniformly mixed). Accordingly, the display region of the display panel (not illustrated) disposed corresponding to the light guide plate 110 can be designed to have a larger area, such that the border width of the display panel can be correspondingly reduced.

The light transparent refraction plate 130 is disposed on the substrate 121 and has several apertures 130a each exposing a corresponding light-emitting surface 122u. Since the sidewall 130s of each aperture 130a has a height H1 larger than the thickness of the light-emitting component 122 and higher than the light-emitting surface 122u, the light L outputted via the edge of the light-emitting surface 122u is refracted to the light guide plate 110 after passing though the light transparent refraction plate 130. Thus, the refraction angle A2 of the light refracted to the light guide plate 110 is larger than the beam angle A1 of the output light before refraction. The larger the height H1 of the sidewall 130s is, the more the light L outputted via the edge of the light-emitting surface 122u will enter the light transparent refraction plate 130. Thus, the light mixing distance S1 can be shortened, the area of dark band can be reduced, and the light outputted via the light guide plate becomes even more uniform.

In the present embodiment of the invention, the lateral surface 122s of the light-emitting component 122 leans against the sidewall 130s of the aperture 130a, such that the edge of the light-emitting surface 122u of the light-emitting component 122 is closest to the sidewall 130s of the light transparent refraction plate 130. Thus, more light L outputted via the light output surface 122u of the light-emitting components 122 will enter the light transparent refraction plate 130, and the intensity of the mixed light will be increased. In another embodiment, as long as the light L outputted via the edge of the light output surface 122u of the light-emitting component 122 is refracted to the light transparent refraction plate 130, the lateral surface of 122s of the light-emitting components 122 can be separated from the sidewall 130s of the aperture 130a by a distance instead of leaning against the sidewall 130s.

The light transparent refraction plate 130 and the light guide plate 110 can be formed from materials such as polycarbonate (PC), polymethyl methacrylate (PMMA), methyl methacrylate polystyrene (MS) or polystyrene (PS). In an embodiment, the light transparent refraction plate 130 is formed from PC having a refractive index being 1.58, and the light guide plate 110 is formed from PMMA having a refractive index of 1.48 smaller than that of PC. In another embodiment, the light transparent refraction plate 130 and the light guide plate 110 can be formed from any material compositions as long as the refractive index of the light transparent refraction plate 130 is larger than that of the light guide plate 110.

Refer to FIG. 1B, the light transparent refraction plate 130 further comprises at least two fixing columns 131 perpendicular to the light transparent refraction plate 130. The fixing columns 131 are respectively located at two ends of the light transparent refraction plate 130. The substrate 121 further comprises at least two first fixing holes 121a corresponding to the two fixing columns 131. The two fixing columns 131 respectively pass through the two first fixing holes 121a for fixing the light transparent refraction plate 130 on the substrate 121. In an embodiment, the outer diameter of each fixing column 131 is slightly larger than the inner diameter of each first fixing hole 121a such that the fixing column 131 can be tightly engaged in the first fixing hole 121a for fixing the light transparent refraction plate 130 on the substrate 121. However, in the embodiment of the invention, the method for fixing the light transparent refraction plate 130 and the substrate 121 is not limited to tight engagement.

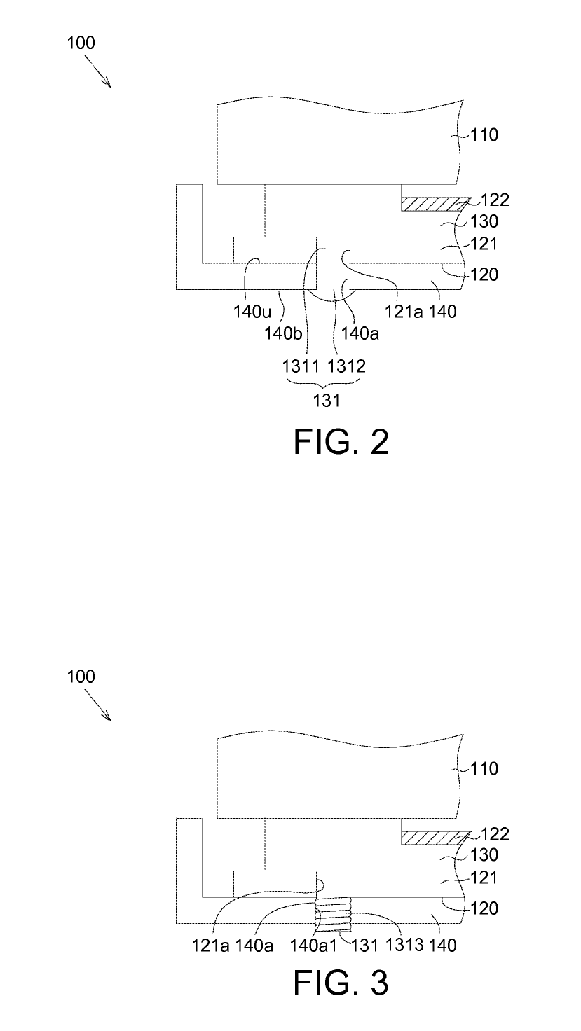

FIG. 2 is a cross-sectional view of a back light module according to another embodiment of the invention. In the present embodiment of the invention, the back light module 100 comprises a light guide plate 110, a light-emitting module 120, a light transparent refraction plate 130 and a frame 140. The frame 140 comprises a front side 140u, a back side 140b and at least two second fixing holes 140a passing through the front side 140u and the back side 140b and corresponding to the two first fixing hole 121a respectively. For simplification purpose, FIG. 2 only illustrates a fixing column 131, a first fixing hole 121a and a second fixing hole 140a. After each fixing column 131 passes through the corresponding first fixing hole 121a, the fixing column 131 further passes through the corresponding second fixing hole 140a for fixing the substrate 121 between the frame 140 and the light transparent refraction plate 130.

As indicated in FIG. 2, each fixing column 131 comprises a column 1311 connected to the light transparent refraction plate 130 and a press head 1312 located at the top of the column 1311. After each fixing column 131 passes through the corresponding first fixing hole 121a and second fixing hole 140a, the press head 1312 of the fixing column 131 presses the back side 140b of the frame 140 around the corresponding second fixing hole 140a for fixing the substrate 121 between the light transparent refraction plate 130 and the frame 140. In an embodiment, the press head 1312 can be formed by a hot melting method.

FIG. 3 is a cross-sectional view of a back light module according to another embodiment of the invention. In the present embodiment of the invention, the fixing column 131 comprises at least several annular engaging flanges 1313, and the second fixing hole 140a further comprises several annular engaging recesses 140a1 in which the annular engaging flanges 1313 can be engaged. Thus, the substrate 121 is fixed between the light transparent refraction plate 130 and the frame 140. Although it is not illustrated in the diagram, each fixing hole 121a has a structure similar to that of the annular engaging recess 140a1.

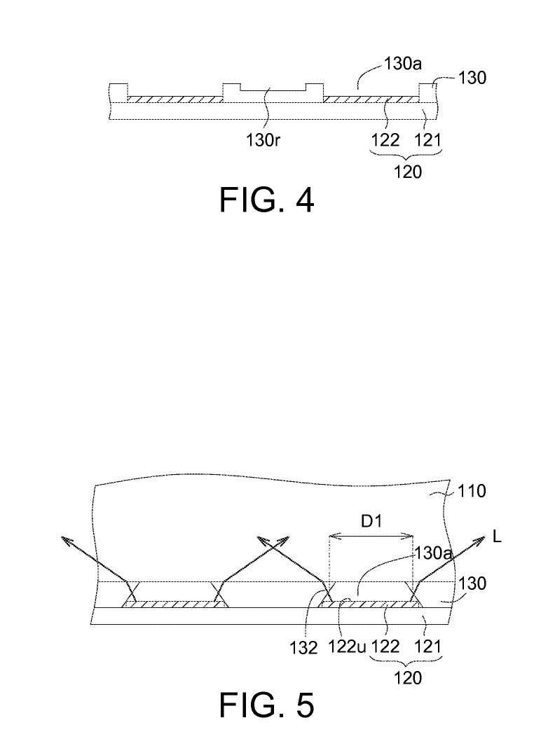

FIG. 4 is a cross-sectional view of a light-emitting module and a light transparent refraction plate according to another embodiment of the invention. In the present embodiment of the invention, each light transparent refraction plate 130 has several recesses 130r. For simplification purpose, FIG. 2 only illustrates one of the recesses 130r. Each recess 130r is located between two adjacent apertures 130a for reducing material consumption for the light transparent refraction plate 130.

FIG. 5 is a cross-sectional view of a back light module according to another embodiment of the invention. In the present embodiment of the invention, the diameter of each aperture 130a of the light transparent refraction plate 130 is inversely proportional to the distance between the aperture 130a and the substrate 121. For example, the farther away from the substrate 121, the smaller the diameter D1 of the apertures 130a, such that the light transparent refraction plate 130 forms an indention 132. The indention 132 partly overlaps the edge of the light output surface 122u of the light-emitting components 122 for increasing the overlapping region between the light transparent refraction plate 130 and the edge of the light-emitting surface 122u, such that more light L outputted via the light-emitting surface 122u of the light-emitting components 122 will be refracted to the light transparent refraction plate 130 to increase the intensity of the mixed light.

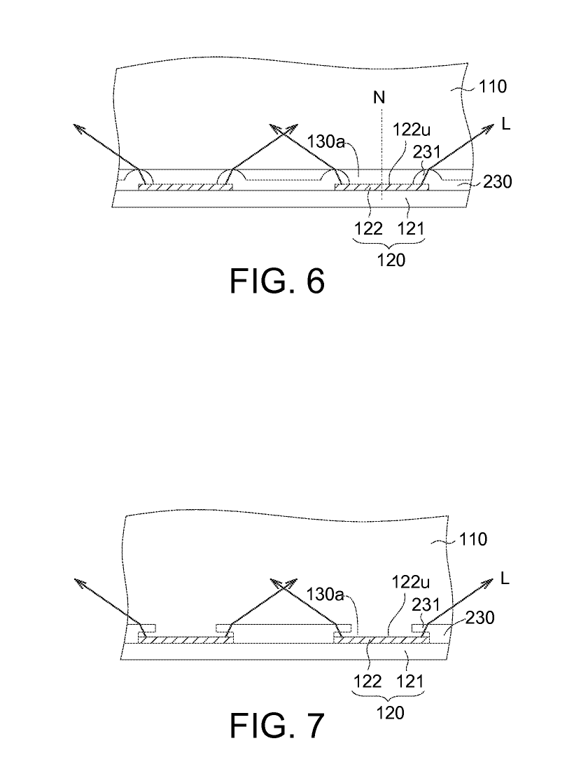

FIG. 6 is a cross-sectional view of a back light module according to another embodiment of the invention. The light transparent refraction plate 230 has several apertures 130a and several annular projections 231, wherein each annular projection 231 extends towards the normal line N of the corresponding light-emitting component 122 from an upper edge of the corresponding aperture 130a to increase the overlapping region between the annular projection 231 and the light-emitting surface 122u. Thus, more light L outputted via the light-emitting surface 122u of the light-emitting components 122 can enter the light transparent refraction plate 130. Besides, in the present embodiment, the annular projection 231 of the light transparent refraction plate 230 directly presses the edge of the corresponding light-emitting surface 122u, such that the light L outputted via the light-emitting surface 122u of the light-emitting components 122 is directly refracted to the light transparent refraction plate 130. However, the embodiment of the invention is not limited thereto. Furthermore, the sectional outer contour of the annular projection 231 can be a curvature, a plane or a combination thereof. The curvature is, for example, at least a portion of a circle or an ellipse, and the plane is, for example, at least a portion of a triangle, a rectangle or a polygon.

FIG. 7 is a cross-sectional view of a back light module according to another embodiment of the invention. Unlike the light transparent refraction plate 230 of FIG. 6, the annular projection 231 of the light transparent refraction plate 230 of the present embodiment does not directly contact the corresponding light-emitting surface 122u but is separated from the corresponding light-emitting surface 122u by a distance. Such design also allows the light L outputted via the light output surface 122u to be refracted to the light transparent refraction plate 230.

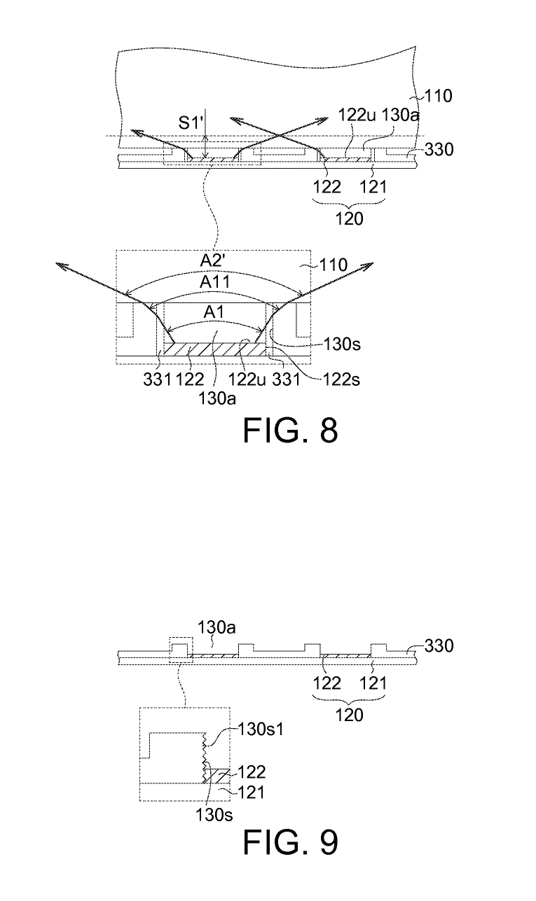

FIG. 8 is a cross-sectional view of a back light module according to another embodiment of the invention. In the present embodiment of the invention, the light transparent refraction plate 330 further comprises an auxiliary refraction layer 331 disposed on the sidewall 130s of the aperture 130a. The lateral surface 122s of the light-emitting components 122 leans against the auxiliary refraction layer 331, such that the edge of the light-emitting surface 122u of the light-emitting components 122 is closest to the auxiliary refraction layer 331, and more light L emitted via the edge of the light-emitting surface 122u will be refracted to the auxiliary refraction layer 331.

Since the refractive index of the auxiliary refraction layer 331 is larger than that of the light transparent refraction plate 330, the light L entering the auxiliary refraction layer 331 will be expanded after entering the light transparent refraction plate 330. That is, the refraction angle All of the light after expansion is larger than the beam angle A1 of the light before expansion. Since the refractive index of the light transparent refraction plate 330 is larger than that of the light guide plate 110, the light L entering the light transparent refraction plate 330 via the auxiliary refraction layer 331 will be expanded after entering the light guide plate 110. That is, the refraction angle A2′ of the light after expansion is larger than the beam angle All of the light before expansion. Refer to the refraction angle A2 of FIG. 1B. Due to the design of the auxiliary refraction layer 331 of the present embodiment, the refraction angle A2′ of the light refracted to the light guide plate 110 of FIG. 8 is larger than the refraction angle A2 of the light refracted to the light guide plate 110 of FIG. 1B. Thus, the light mixing distance S1′ can be smaller than the light mixing distance S1. In an embodiment, the auxiliary refraction layer 331 can be formed from materials such as polycarbonate, polymethyl methacrylate, polystyrene, methacrylate or polystyrene, and the auxiliary refraction layer 331 and the light transparent refraction plate 330 can be formed from any material compositions as long as the refractive index of the auxiliary refraction layer 331 is larger than that of the light transparent refraction plate 330.

FIG. 9 is a cross-sectional view of a light-emitting module and a light transparent refraction plate according to another embodiment of the invention. In the present embodiment of the invention, the sidewall of 130s of the aperture 130a has a roughness structure 130s1, which provides an optical effect similar to the auxiliary refraction layer 331 and is capable of increasing light scattering. Detailed descriptions of the roughness structure 130s1 are not repeated here.

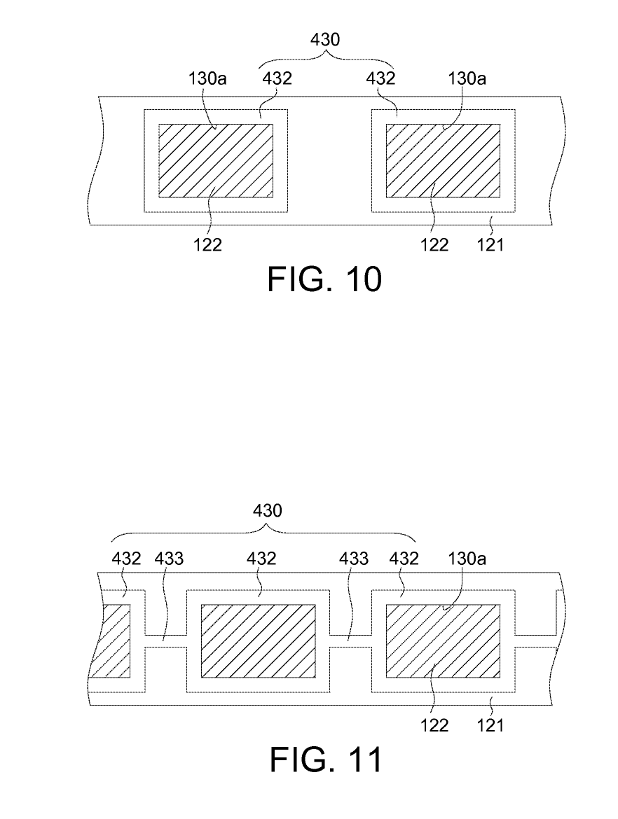

FIG. 10 is top view of a light-emitting module and a light transparent refraction plate according to another embodiment of the invention. In the present embodiment of the invention, the light transparent refraction plate 430 comprises several sub-transparent plates 432 separated from each other. Each sub-transparent plate 432 has an aperture 130a. Due to the separate disposition of the sub-transparent plates 432, the materials which would otherwise be required for connecting the sub-transparent plates 432 can thus be saved, and the overall material consumption of the light transparent refraction plate 430 can accordingly be saved.

FIG. 11 is a top view of a light-emitting module and a light transparent refraction plate according to another embodiment of the invention. Unlike the light transparent refraction plate 430 of FIG. 10, the light transparent refraction plate 430 of the present embodiment further comprises several connection strips 433, wherein every two sub-transparent plates 432 are connected by a connection strip 433. Since the connection strip 433 has a width smaller than that of sub-transparent plate 432, the overall material consumption of the light transparent refraction plate 430 still can be saved.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A back light module, comprising:
a light-emitting module, comprising a substrate and a plurality of light-emitting components disposed on the substrate, wherein each light-emitting component has a light-emitting surface;
a light transparent refraction plate disposed on the substrate and having a plurality of apertures each exposing a corresponding light-emitting surface, wherein sidewalls of the apertures are higher than the light-emitting surfaces; and
a light guide plate whose lateral side has a light incident surface facing the light-emitting surfaces and pressing the light transparent refraction plate;
wherein, a refractive index of the light transparent refraction plate is larger than a refractive index of the light guide plate, and light emitted by each light-emitting component is refracted to the light guide plate after passing through the light transparent refraction plate.

2. The back light module according to claim 1, wherein a diameter of each aperture of the light transparent refraction plate is inversely proportional to the distance between the aperture and the substrate.

3. The back light module according to claim 1, wherein each aperture further comprises an annular projection which extends towards a normal line of the corresponding light-emitting component from an upper edge of the corresponding aperture and partly overlaps the corresponding light-emitting surface.

4. The back light module according to claim 3, wherein each annular projection directly presses an edge of the corresponding light-emitting surface.

5. The back light module according to claim 1, wherein each light transparent refraction plate further has a plurality of recesses each being located between adjacent two apertures.

6. The back light module according to claim 1, the light transparent refraction plate further comprises at least two fixing columns perpendicular to the light transparent refraction plate and respectively located at two ends of the light transparent refraction plate, and the substrate further comprises at least two first fixing holes corresponding to the two fixing columns passing through the two first fixing holes for fixing the light transparent refraction plate on the substrate.

7. The back light module according to claim 6, further comprising a frame, which comprises a front side, a back side, and at least two second fixing holes passing through the front side, the back side and corresponding to the two first fixing holes respectively, wherein after passing through the two first fixing holes, the two fixing columns further pass through the two second fixing hole for fixing the substrate between the frame and the light transparent refraction plate.

8. The back light module according to claim 7, wherein each fixing column respectively comprises a plurality of annular engaging flanges and each second fixing hole further comprises a plurality of annular engaging recesses in which the annular engaging flanges are engaged.

9. The back light module according to claim 7, wherein each of the two fixing columns comprises a column connected to the light transparent refraction plate and a press head located at the top of the column, and after each fixing column passes through the corresponding first and second fixing holes, the press head of each fixing column respectively presses a back side of the frame around the corresponding second fixing hole.

10. The back light module according to claim 1, wherein the sidewall of each aperture further comprises a roughness structure or an auxiliary refraction layer.

11. The back light module according to claim 10, wherein the auxiliary refraction layer is respectively disposed on the sidewall of each aperture, and the lateral surface of each light-emitting component respectively leans against the auxiliary refraction layer of the sidewall of the corresponding aperture, and the refractive index of the auxiliary refraction layer is larger than that of the light transparent refraction plate.
